(19) United States
(12) Patent Application Publication
(10) Pub. No.: US 2026/0010197 A1
(43) Pub. Date: Jan. 8, 2026

(54) ACCESSORY TO CARRY A PORTABLE COMPUTING DEVICE

(71) Applicant: Adam Brown, Grand Rapids, MI (US)

(72) Inventor: Adam Brown, Grand Rapids, MI (US)

(21) Appl. No.: 18/764,232

(22) Filed: Jul. 4, 2024

(51) Int. Cl. G06F 1/16

(52) U.S. Cl. CPC G06F 1/1628; G06F 1/1681; G06F 2200/1632

(57) ABSTRACT

The invention relates to an accessory for portable computing devices, specifically laptops and notebooks, to facilitate carrying via a conventional handle. This accessory comprises a flexible harness that can be inserted through the space between the screen and keyboard of the device, engaging around its hinges without requiring any modifications to the device. A loop on the harness accepts a rigid crosspiece that transfers carrying loads to a handle by sliding through holes on either side of the handle. A flexible slider moves along the crosspiece to cover the harness loop, preventing it from detaching. The fitment between the slider and crosspiece is designed to provide friction, ensuring stability. Additionally, the handle can fold back onto the device for convenient storage in a bag. The overall design enables secure, briefcase-like transport of the portable computing device.

### FIELD OF THE INVENTION

The present invention pertains to the field of portable computing devices and accessories. Specifically, it relates to an accessory designed for portable computing devices, such as laptops and notebook computers, which enables secure and convenient transportation of these devices. The accessory includes a handle mechanism that allows the portable computing device to be carried like a briefcase, ensuring ease of transport and minimizing the risk of dropping. This invention is relevant to the domains of computer hardware design, ergonomic accessory development, and portable device enhancements.

### BACKGROUND OF THE INVENTION

Portable computing devices such as laptops and notebook computers have become essential tools for professionals and students alike. These devices are typically designed to be compact and lightweight, facilitating easy transport. However, despite these design considerations, laptops and notebooks often lack integrated carrying handles, necessitating the use of external bags or cases for transportation. This can be inconvenient and increases the risk of the device being dropped. In order to transport these portable electronic devices, the user either needs to use a bulky case or bag with a flexible harness or carry it by hand.

Several prior art solutions have attempted to address this issue. For instance, U.S. Pat. No. 7,643,274 discloses an exterior cover for laptop computers designed to enhance grip and protection. It includes rigid planar elements for placement on the display and keyboard portions of the laptop. The elements feature raised edges with tabs for gripping, aimed at improving handling and safeguarding the laptop from external impacts. While effective in enhancing grip and protection, this invention focuses primarily on external modifications to the laptop's surfaces rather than providing a built-in carrying solution.

U.S. Pat. No. 7,819,247, discloses a multifunction carrying case capable of transforming into a laptop stand. This case integrates a stand assembly within a housing similar to a hard-sided briefcase. The stand assembly includes telescoping risers and bases to adjust the height of the laptop stand, providing versatility for different usage scenarios. This invention emphasizes dual functionality as both a protective case and a stand, offering users flexibility in how they use and transport their laptops. However, it primarily addresses stationary use and does not provide a solution for carrying the laptop securely while in transit.

U.S. Patent Application Publication No. 2009/0039124, discloses a universal carrying apparatus designed for laptops and other electronic devices with dual hinges. The apparatus is threaded through the gap between the screen and the keyboard deck, anchoring against the hinges to support the device's weight. While effective in providing a secure carry solution, this design lacks an efficient mechanism to ensure the apparatus remains securely in place, particularly during movement. The absence of a dedicated locking mechanism means the apparatus might shift or disengage under certain conditions.

U.S. Patent Application Publication No. 2021/0100329, discloses a carry strap for electronic display devices, including laptops and tablets. The strap can be attached to the device either directly or via an adhesive mantle. While this invention offers a versatile carrying solution, it relies on adhesive methods which may not be universally reliable and can leave residues on the device. Moreover, the strap lacks a dedicated locking mechanism to ensure it stays securely attached to the device.

U.S. Patent Application Publication No. 2003/0075578, discloses a tether arrangement for connecting electronic devices to a person. This flexible cord system is designed to prevent devices from falling off a user's lap while seated. Although effective for securing the device during use, it is not optimized for carrying the device in a briefcase-like manner. Additionally, the tethers may not provide sufficient stability and security when used for carrying purposes, as they lack a dedicated mechanism to prevent the tethers from slipping or disengaging.

### Challenges in Prior Art

Despite the advancements in laptop accessories and protective cases, there remains a gap in solutions that facilitate secure and comfortable carrying of laptops without compromising their inherent design and functionality. Many existing solutions either require permanent modifications to the laptop's exterior, are limited to specific laptop models, or do not adequately address the ergonomic and portability needs of users.

The present invention addresses the aforementioned challenges by introducing a novel accessory designed to facilitate safe and convenient handling of portable computing devices, such as laptops and notebooks. The invention provides a solution that integrates seamlessly with a wide variety of laptop models without requiring modifications to the device itself. This allows users to maintain the integrity of their laptops while enhancing portability and user experience.

The present invention improves upon the prior art by introducing a portable computing device accessory that features a unique slider mechanism. This accessory allows a handle to be securely attached to a wide variety of laptops without requiring any modifications to the device.

The flexible harness is threaded through the gap between the laptop's screen and keyboard, wrapping around the hinges. A loop at the end of the harness accepts a rigid crosspiece, which is then connected to the handle.

The key innovation is the inclusion of a flexible slider that moves along the rigid crosspiece to cover the harness loop. This slider ensures the harness remains securely in place, preventing it from coming off during use. The fitment between the slider and the crosspiece is engineered to provide sufficient friction, ensuring stability unless intentional force is applied. This design not only facilitates secure handling but also allows the handle to fold back, enabling the laptop to be easily stowed in a bag.

By focusing on the slider mechanism, this invention addresses the limitations of previous solutions, offering a secure, versatile, and non-intrusive method to enhance the portability of laptops, providing a practical and reliable carrying solution akin to a briefcase.

### SUMMARY OF THE INVENTION

The present invention addresses a fundamental issue in the realm of portable computing devices: the secure and convenient transport of laptops and notebooks without compromising their functionality or design integrity. It introduces a novel accessory designed to integrate seamlessly with a broad range of laptop models, providing users with a robust handle directly incorporated into the laptop structure.

Laptops and notebooks have become indispensable tools in both professional and personal environments due to their mobility and versatility. However, their design typically lacks built-in handles, making secure transportation a challenge. Users often resort to external bags or precarious gripping methods, risking accidental drops and potential damage to the device.

The current invention aims to resolve these challenges by introducing an accessory that enhances the portability and user experience of laptops without altering their original design. By integrating a handle directly into the laptop structure through a unique harness and crosspiece mechanism, the invention offers a practical solution for users seeking secure and comfortable laptop transport.

The invention consists of key components designed to achieve its objectives effectively:

“Flexible Harness” refers to a thin, flexible harness is inserted through the space between the laptop screen and keyboard, wrapping securely around the hinges of the device. This harness is designed to be slim enough to fit through the existing gap without requiring modifications to the laptop's structure.

“Loop and Rigid Crosspiece” refers to a flexible harness at the end, a loop is formed. A rigid crosspiece, typically made from durable materials such as metal or reinforced plastic, is threaded through this loop after the harness is correctly positioned around the laptop hinges. The rigid crosspiece serves as the structural support for the carrying handle, ensuring stability and durability.

“Handle Assembly” refers to a handle features strategically placed holes on either side through which the rigid crosspiece slides. This design facilitates the transfer of carrying forces from the laptop hinges to the handle, distributing weight evenly and minimizing stress on the laptop's structure. The handle is ergonomically designed to provide a comfortable grip, enhancing usability during transport.

“Flexible Slider” refers to a flexible slider covers and secures the loop of the harness. This prevents accidental disassembly during use, with the fitment between the slider and crosspiece providing sufficient friction for stability while allowing for easy adjustment.

“End Cap” refers to secure the entire assembly, an end cap is affixed to the end of the rigid crosspiece. This end cap is securely attached, typically with adhesive, to prevent unintended movement or disassembly of the handle mechanism, adding stability and ensuring the integrity of the carrying solution.

The invention offers several key advantages and benefits over existing solutions:

Universal Compatibility: Unlike many prior solutions tailored to specific laptop models or requiring external modifications, the invention is universally compatible. It seamlessly integrates with a wide range of laptops, accommodating various sizes, shapes, and hinge configurations without altering the device.

Enhanced Portability: By integrating a handle directly into the laptop's structure, the invention significantly enhances portability. Users can securely carry their laptops, akin to a briefcase, without the need for additional bags or accessories.

Preserved Functionality: Crucially, the invention preserves the laptop's functionality while in use. The screen can open and close freely without obstruction, and the handle can fold back onto the laptop for easy storage.

User-Friendly Design: The invention prioritizes ease of assembly and use. The assembly process involves straightforward steps, such as inserting the harness through the laptop's hinge area and attaching the crosspiece and handle. This simplicity enhances user adoption and usability.

Durability and Ergonomics: Components like the rigid crosspiece and handle are designed for durability and comfort. The handle provides a secure grip, reducing user fatigue during extended carrying periods. Market Viability: Positioned as a commercially viable solution, the invention addresses a significant market need for enhanced laptop portability. It offers a cost-effective alternative to existing accessories, appealing to professionals, students, and everyday users who rely on laptops.

In conclusion, the invention represents a significant advancement in portable computing device accessories by addressing the challenge of secure and convenient laptop transport. By leveraging innovative design principles and integrating seamlessly with existing laptop features, the invention enhances portability and user experience without compromising device integrity. This innovation is poised to meet the diverse needs of a growing market, providing a practical solution that enhances mobility and convenience in daily use scenarios.

### BRIEF DESCRIPTION OF THE ACCOMPANYING DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings, in which:

FIG. 1 illustrates perspective view of the accessory designed for portable computing devices, such as laptops and notebook computers, which enables secure and convenient transportation of these devices;

FIG. 2 illustrates a perspective view of the invention with the laptop and the flexible harness;

FIGS. 3 & 4 illustrates the loop engagement with the hinge of the device;

FIGS. 5 & 6 illustrates perspective view focus on harness and slider arrangement;

FIG. 7 illustrates is a perspective view of the accessory to carry a portable computing device;

FIG. 8 is a perspective view of the accessory with the portable computing device;

FIG. 9 illustrates is a perspective view of the accessory to carry a portable computing device with pen holder;

FIG. 10 illustrates is a perspective view of the accessory to carry a portable computing device with pen holder securely holding a pen, stylus, or similar writing instrument;

FIG. 11 illustrates the person carrying the accessory with a portable computing device;

FIG. 12, illustrates the assembly of the invention which is designed to be straightforward and user-friendly, accommodating users of varying technical expertise. The process involves several sequential steps to ensure the secure attachment and functionality of the handle.

### DETAILED DESCRIPTION

This disclosure pertains to articles designed for carrying electronic devices, such as laptop computers and tablets, with a particular focus on laptop carrying straps. Various embodiments are detailed with reference to the drawings, where similar reference numerals may denote similar parts and assemblies across the multiple views. Mentioning various embodiments does not restrict the scope of the systems and methods disclosed herein. While examples of construction, dimensions, and materials may be illustrated for different elements, those skilled in the art will recognize that many of the provided examples have suitable alternatives. The examples in this specification are not intended to be limiting but merely illustrate some of the numerous possible embodiments for the systems and methods. It is understood that various omissions and substitutions of equivalents are anticipated as circumstances may suggest or necessitate, but these are intended to encompass applications or embodiments without deviating from the spirit or scope of the disclosure. Additionally, the phraseology and terminology used herein are for descriptive purposes and should not be regarded as limiting.

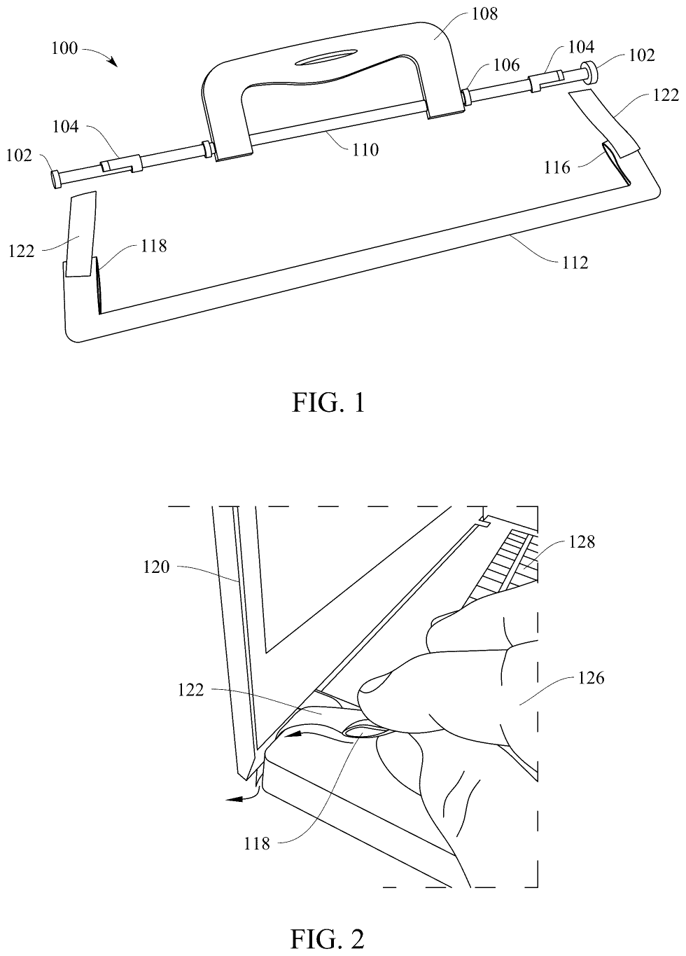

FIG. 1 illustrates an invention addressing a critical issue in the realm of portable computing devices: the securely and conveniently transporting of laptops and notebooks without compromising their functionality or design integrity. Developed as an accessory (100) for carry a portable computing device, it includes a robust handle (108) integrated directly into the laptop's structure through a unique harness (112) and a rigid crosspiece (110) mechanism. The harness (112) features a guide tabs (122) and a harness loops (116, 118) configured to facilitate passage between a laptop screen (120) and a keyboard (128). The rigid crosspiece (110) comprises a flexible slider (104), an end caps (102) and a stoppers (106). This detailed description delves into the construction, functionality, assembly process, and advantages of the invention, highlighting its novel approach and practical application in enhancing laptop portability.

Portable computing devices, particularly laptops and notebooks, have revolutionized how individuals work, study, and communicate by offering mobility and flexibility. However, the design of these devices typically lacks built-in handles, which poses challenges in their safe and comfortable transport. Users often resort to external bags or awkward gripping methods, increasing the risk of accidental drops and potential damage.

The current invention aims to address these challenges by providing a versatile accessory that enhances the portability of laptops without requiring modifications to the device itself. By integrating a handle (108) directly into the laptop's structure, the invention offers users a secure and ergonomic solution for carrying their laptops, akin to carrying a briefcase.

One aspect of a disclosed carrying strap for electronic display devices is provided herein. An embodiment of the handle for a laptop computer includes a first elongated portion structured and configured to be hold by a user. The handle can be made from various materials such as leather, vinyl, fabric, yarn, cords, woven fabric, nonwoven fabric, or metal.

Referring to FIGS. 2 to 10 the present invention which further comprises several key components designed to work synergistically to achieve its objectives of enhancing laptop portability while preserving functionality.

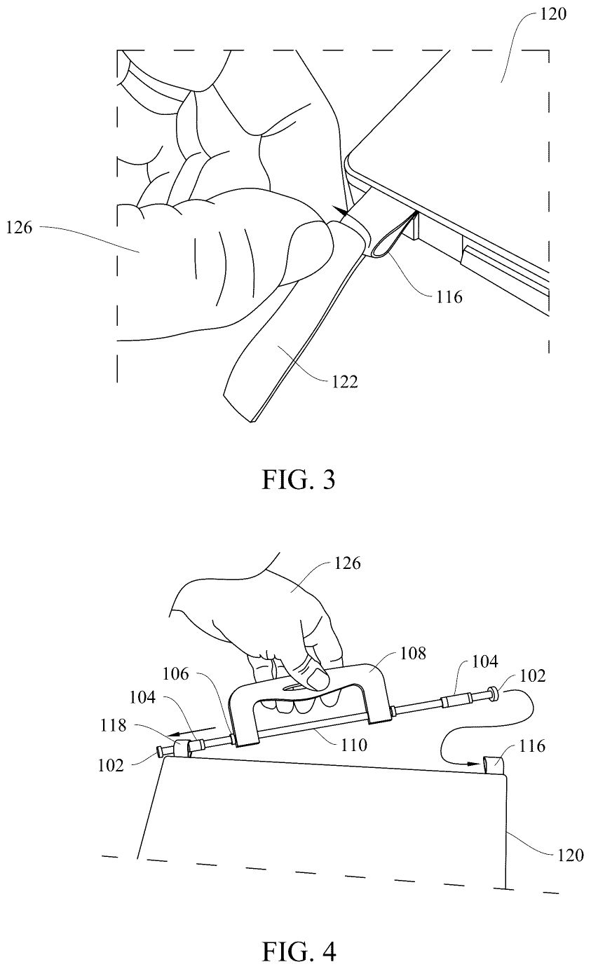

In FIG. 2, the fundamental component of the invention is a thin, flexible harness (112). This harness (112) is designed to be inserted through the gap between the laptop screen (120) and keyboard (128), where it securely along the side of hinges (114) of the laptop or notebook device. The material of the harness (112) is selected for its flexibility and durability, ensuring it can withstand repeated use without degradation. The flexible harness (112) includes guide tabs (122) configured to facilitate passage between a laptop screen (120) and keyboard (128). The guide tabs (122) are adapted to enter a narrow gap between the laptop screen (120) and keyboard (128) (as marked by arrow), aiding the harness loops (116, 118) in passing through. In FIG. 3, showing that as the harness loops (116, 118) become fully visible on the exterior of the laptop, the guide tabs (122) are peeled off.

The flexibility of the harness (112) is crucial as it allows it to conform to different laptop sizes and hinge configurations without the need for device-specific customization. This universal compatibility is a significant advantage over prior art solutions that often require modifications to the laptop's exterior or internal structure.

In FIG. 4, illustrate a loop (116, 118) that formed at the free end of the flexible harness (112). This loop (116, 118) serves as the attachment point for a rigid crosspiece (110), which provides structural support to the handle (108) assembly. The rigid crosspiece (110) is typically made from materials such as metal or reinforced plastic, chosen for their strength and lightweight properties.

The assembly process involves threading the rigid crosspiece (110) through the loop (116, 118) of the flexible harness (112) after it has been securely passed alongside of the laptop hinges (114). This step ensures that the handle (108) assembly is firmly attached to the laptop, capable of supporting the weight of the laptop or notebook device during transport. The rigid crosspiece (110) comprises a stopper (106) configured to prevent sliding and enhance stability of the handle (108).

The handle (108) itself is a pivotal component of the invention, designed to provide a secure and comfortable grip for the user. It features holes strategically positioned on either side, through which the rigid crosspiece (110) slides. These holes are engineered to distribute carrying forces evenly, minimizing stress on the laptop hinges (114) and ensuring stability during transport.

Handle assembly (108) can be made from many materials such as leather, vinyl, reinforced plastic, metal, metal foil, reinforced fabric such as fabric embedded with a mat-like binder or fabric intercalated with a polymeric coating, tapestry, woven or nonwoven materials, rubber, nylon synthetics, or any blended hybrid of these.

Ergonomics plays a crucial role in the design of the, as it aims to reduce user fatigue during prolonged carrying periods. The material selected for the handle (108) is chosen for its grip and comfort, enhancing the overall user experience while maintaining a sleek and integrated appearance with the laptop.

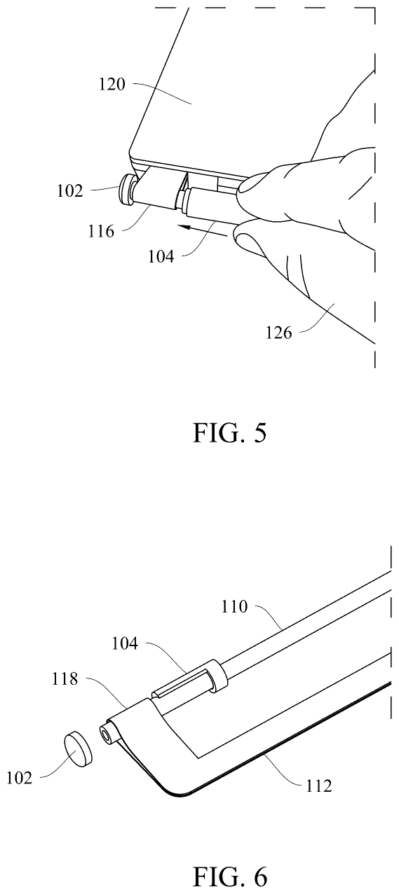

To secure the flexible harness (112) and rigid crosspiece (110) assembly, a flexible slider (104) component is incorporated along the length of the rigid crosspiece (110). This slider (104) serves multiple functions: it covers and secures the loop (116, 118) of the harness (112), preventing accidental disassembly; it provides adjustable friction to maintain the position of the harness during use; and it enhances the overall stability of the handle assembly, as depicted in FIG. 5.

The design of the slider (104) ensures that it moves smoothly along the rigid crosspiece (110) while maintaining sufficient friction to prevent unintended movement. This feature is critical in ensuring the reliability and durability of the handle assembly, particularly under varying carrying conditions, as depicted in FIG. 5.

To finalize the assembly and secure the rigid crosspiece (110) in place, an end cap (102) is attached to the end of the crosspiece. The end cap (102) serves as a protective barrier, preventing the flexible slider (104) from sliding out of the rigid crosspiece (110) and ensuring the integrity of the entire carrying solution.

The attachment of the end cap (102) is typically done using adhesive or a secure fastening method, ensuring it remains firmly in place throughout the lifespan of the handle assembly. This final step completes the robust construction of the handle (108), readying it for practical use in carrying the laptop, as depicted in FIG. 6.

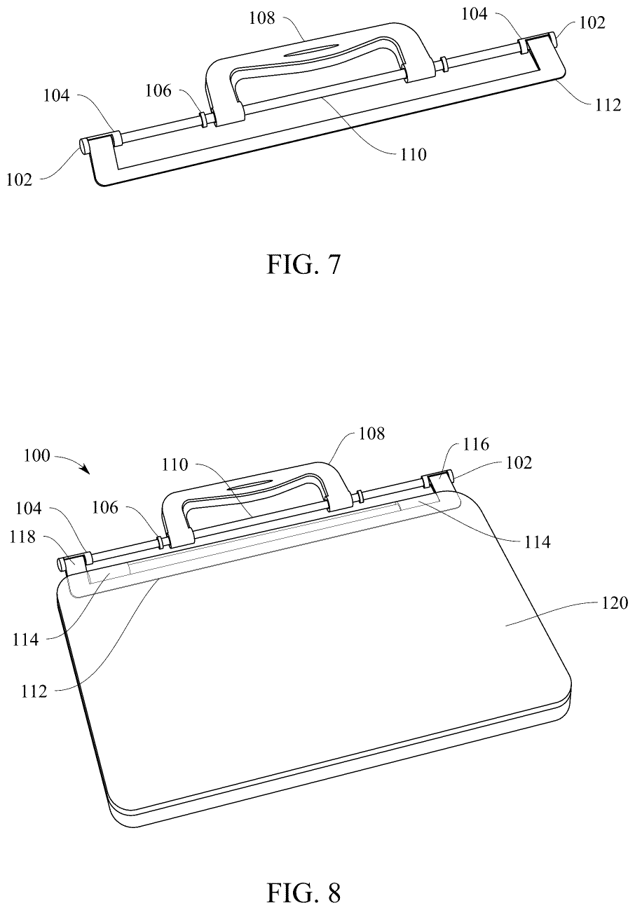

FIG. 7 illustrates the complete accessory (100) with all components properly positioned. The flexible slider (104) tightly attaches to the loops (116, 118), and the end caps (102) secure the sliders (104) to prevent it from dislodging from the rigid crosspiece (110). FIG. 8 depicts the accessory (100) connected to a laptop or notebook device.

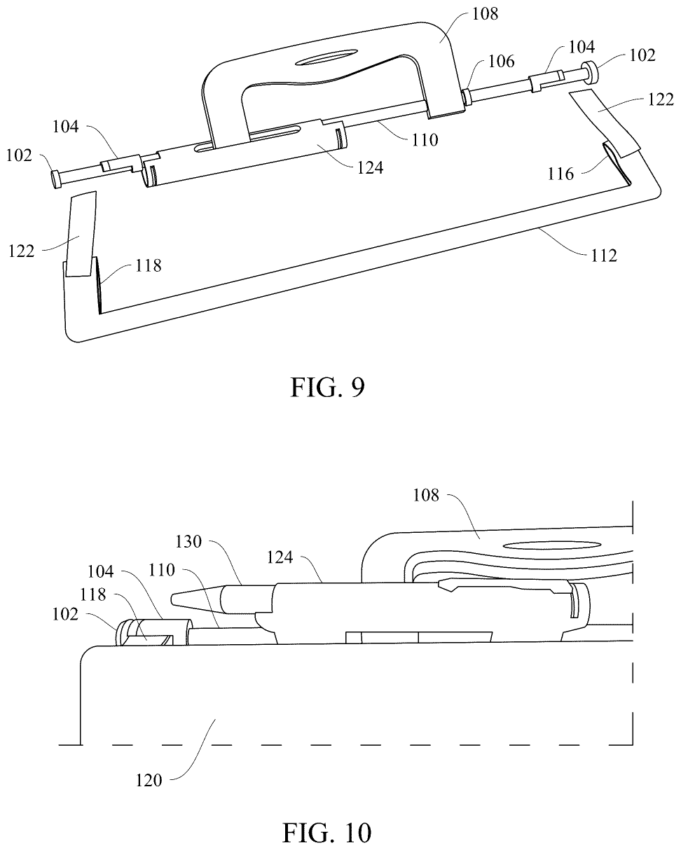

Referring to FIGS. 9 and 10, the invention also includes a pen holder (124) integrated into the handle (108), adding an extra layer of convenience for users who frequently need a pen (130) or stylus. This feature is particularly useful for professionals and students who need to take notes or sign documents on the go.

In an alternative embodiment, the invention includes an integrated pen holder (124) within the handle (108), providing additional convenience for users who frequently need a pen or stylus (130).

The pen holder (124) is strategically positioned along the length of the handle (108) to balance weight distribution and maintain ergonomic comfort. Its location ensures that the handle remains easy to grip and use without interference from the pen holder (124).

The pen holder (124) is designed to securely hold a pen, stylus, or similar writing instrument. It includes a locking mechanism to prevent the pen or stylus (130) from falling out during transport, ensuring that the user always has a writing tool readily available.

The pen holder (124) is constructed from durable materials to withstand the rigors of daily use. Its robust construction ensures that it retains its shape and functionality over time, providing reliable service to the user.

The pen holder's design allows for easy access to the pen or stylus (130), facilitating quick retrieval and storage. This feature is particularly beneficial for professionals and students who need to take notes or sign documents on the go.

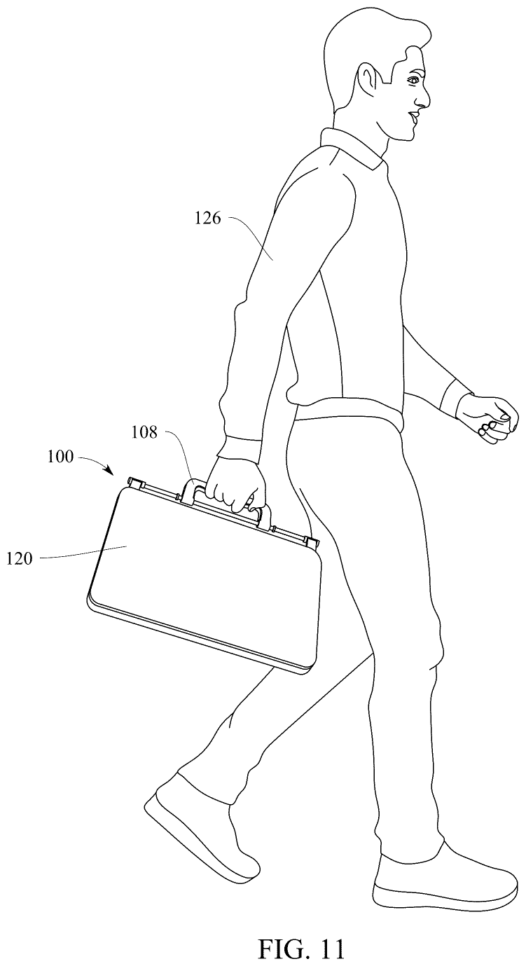

FIG. 11 depicts components of an accessory (100) for carry a portable computing device made according to embodiments, as it might be grip by hand (126) of user. The primary objective is to provide a portable computing device accessory that can be universally adapted to a wide variety of laptop models without requiring any modifications to the laptop itself. This ensures that users can conveniently and securely carry their laptops regardless of the specific make or model. The accessory (100) aims to facilitate secure and comfortable handling of laptops during transport. By integrating a handle (108) directly into the laptop's structure through a unique harness (112) and crosspiece mechanism (110), the invention distributes carrying forces effectively and minimizes the risk of accidental drops or damage. The accessory (100) allows the laptop screen to open and close without obstruction and can be folded back onto the device, enabling easy insertion into bags or other carrying cases.

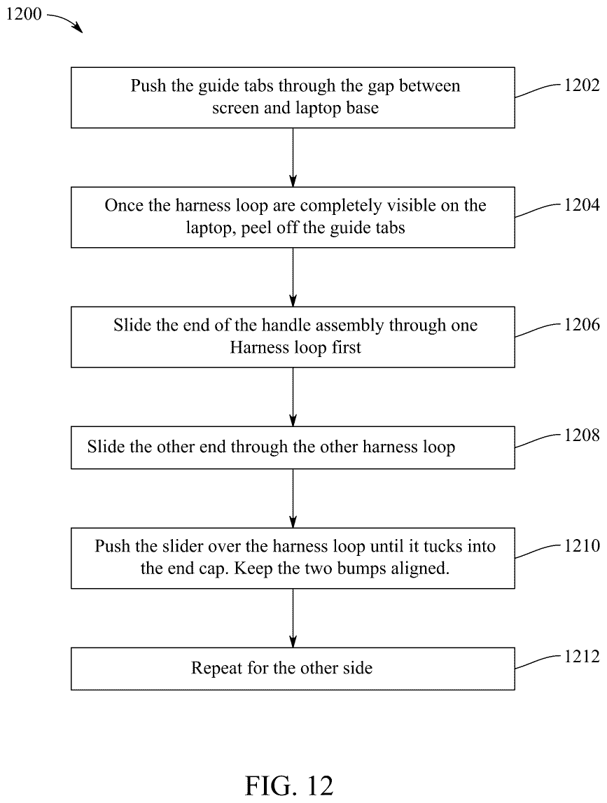

Referring to FIG. 12, the assembly of the invention which is designed to be straightforward and user-friendly, accommodating users of varying technical expertise. The process (1200) involves several sequential steps to ensure the secure attachment and functionality of the handle (108):

Preparation: Before assembly, the user ensures that the laptop is positioned on a stable surface with the screen open to access the hinges. The flexible harness (112) is inspected for any twists or kinks that could affect its proper installation.

Step 1202 involves carefully inserting the harness loops (116, 118) with the assistance of guide tabs (122) through the gap between the laptop screen (120) and keyboard (128).

Step 1204 involves the guide tabs (122) are adapted to enter a narrow gap between the laptop screen (120) and keyboard (128), aiding the harness loops (116, 118) in passing through. This gap serves as the pathway for the harness to engage with the hinges of the laptop. The flexibility of the harness ensures it can navigate through tight spaces without requiring any modifications to the laptop's exterior or internal components.

The harness loops (116, 118) become fully visible on the exterior of the laptop, the guide tabs (122) are peeled off.

Step 1206 and Step 1208 involves the loops (116, 118) that are formed at end of the flexible harness (112). A rigid crosspiece (110) is then threaded through this loops after the harness is properly positioned around the hinges (114) of the laptop. This crosspiece (110) serves as the structural support for the carrying handle.

Step 1210 involves the flexible slider (104) is positioned along the rigid crosspiece (110) to cover and secure the loop (116, 118) of the harness (112), preventing accidental disassembly during use. The fitment between the slider and crosspiece is controlled to provide sufficient friction, ensuring stability while allowing easy adjustment when needed.

This step establishes the structural connection between the laptop hinges and the handle assembly.

Once assembled, the invention operates seamlessly to enhance the portability and usability of the laptop:

The integrated handle (108) allows users to securely carry the laptop, similar to carrying a briefcase, without the need for additional bags or accessories. The distribution of carrying forces through the hinges and rigid crosspiece (110) minimizes stress on the laptop's structure, reducing the risk of damage due to drops or mishandling.

Crucially, the invention does not obstruct the functionality of the laptop. Users can open and close the screen freely, adjust the viewing angle, and utilize all ports and features without impediment. The handle (108) can be folded back onto the laptop, facilitating easy insertion into bags or storage compartments.

Designed with user comfort in mind, the handle's ergonomic shape and material ensure a comfortable grip during transport. This ergonomic consideration reduces hand fatigue and enhances usability during prolonged carrying periods, catering to the practical needs of professionals, students, and everyday users alike.

Referring to FIG. 12, the arrangement and attachment mechanism of the invention are crucial aspects that ensure its functionality, stability, and compatibility across a variety of laptop models. This section delves into the detailed arrangement of components and the method of attachment, highlighting how the invention integrates seamlessly with different laptop configurations.

In conclusion, the arrangement and attachment mechanism of the invention play a pivotal role in its functionality and usability as a portable computing device accessory. By strategically integrating components such as the flexible harness (112), rigid crosspiece (110), handle (108), flexible slider (104), end cap (102), and pen holder (124), the invention provides a robust solution for enhancing laptop portability without compromising laptop or notebook device functionality or design integrity. This detailed description underscores the innovation's practical application and potential impact in meeting the diverse needs of laptop users, offering a reliable and ergonomic solution for secure laptop transport in various daily use scenarios.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein—and in particular, embodiment specifically contemplated, is intended to be practiced in the absence of any element which is not specifically disclosed herein.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. An accessory to carry a portable computing device, comprising:
a flexible harness configured to be inserted through a space between a screen and a keyboard of the portable computing device, wherein the harness arranged alongside of hinge of the device;
a loop formed on a free end of the said flexible harness;
a rigid crosspiece configured to slide through the said loop after the harness is assembled to the device;
a handle with holes on either side, through which the rigid crosspiece slides, transferring carrying loads to the handle;
a flexible slider configured to move along the rigid crosspiece and cover the loop of the harness, thereby preventing the harness from coming off,
wherein the fitment between the flexible slider and the rigid crosspiece is controlled to provide sufficient friction to prevent movement unless sufficient force is applied; and
an end cap configured to be secured to an end of the rigid crosspiece to retain the crosspiece in place.

2. The accessory of claim 1, wherein the flexible harness allows the screen of the portable computing device to open and close without obstruction.

3. The accessory of claim 1, wherein the handle is capable of folding back onto the portable computing device to allow the device to easily slide into a bag.

4. The accessory of claim 1, wherein the end cap is glued to the end of the rigid crosspiece tube.

5. The accessory of claim 1, wherein the flexible harness is thin enough to fit through the space between the screen and the keyboard without requiring any modification to the portable computing device.

6. The accessory of claim 1, wherein the rigid crosspiece is constructed from a material sufficiently strong to support the weight of the portable computing device when carried by the handle.

7. The accessory of claim 1, wherein the handle is constructed from a material that provides a comfortable grip for the user.

8. The accessory of claim 1, wherein the flexible slider is constructed to maintain its position on the rigid crosspiece under normal use conditions, thereby securing the harness loop.

9. The accessory of claim 1, wherein the handle is configured to provide secure transport of the portable computing device similar to a briefcase.

10. The accessory of claim 1, further comprising a pen holder integrated into the handle.

11. The accessory of claim 10, wherein the pen holder is positioned along the length of the handle to balance the weight distribution.

12. The accessory of claim 10, wherein the pen holder is constructed to securely hold a pen, stylus, or similar writing instrument.

13. The accessory of claim 10, wherein the pen holder includes a locking mechanism to prevent the pen or stylus from falling out during transport.

14. A method of assembling an accessory handle to a portable computing device, comprising:
inserting a flexible harness through a space between a screen and a keyboard of the portable computing device;
engaging the flexible harness around the hinge of the device;
forming a loop on a free end of the flexible harness;
sliding a rigid crosspiece through the loop;
attaching a handle by sliding the rigid crosspiece through holes on either side of the handle;
moving a flexible slider along the rigid crosspiece to cover the harness loop; and
securing an end cap to the end of the rigid crosspiece.

15. The method of claim 14, further comprising ensuring the flexible harness allows the screen to open and close without obstruction.

16. The method of claim 14, further comprising folding the handle back onto the portable computing device for easy insertion into a bag.

17. The accessory of claim 1, wherein the rigid crosspiece and handle are designed to distribute the carrying load evenly across the handle to enhance stability during transport.

18. The accessory of claim 1, wherein the handle includes a locking mechanism to secure the handle in a folded position when not in use.

19. The accessory of claim 1, wherein the flexible harness includes reinforcement at stress points to increase durability.

20. The accessory of claim 1, wherein the handle is ergonomically shaped to reduce hand fatigue during prolonged carrying.

21. The accessory of claim 1, further comprising a detachable strap that can be connected to the handle for shoulder carrying.

22. The accessory of claim 1, wherein the end cap is constructed to snap fit onto the end of the rigid crosspiece, providing a secure and easy assembly.

23. The accessory of claim 1, wherein the flexible slider is made from a material with a high coefficient of friction to enhance its holding capacity on the rigid crosspiece.
